(19) United States
(12) Patent Application Publication
(10) Pub. No.: US 2012/0047705 A1
(43) Pub. Date: Mar. 1, 2012

(54) PROCESS AND METHOD OF IMPLEMENTING RESERVOIR COVERS

(76) Inventor: David Yekutiely, Ramat HaSharon (IL)

(21) Appl. No.: 13/033,713

(22) Filed: Feb. 24, 2011

Related U.S. Application Data
(60) Provisional application No. 61/307,459, filed on Feb. 24, 2010.

(51) Int. Cl. B23P 11/00; B32B 37/06

(52) U.S. Cl. 29/428; 156/349

(57) ABSTRACT

A method for creating a covering for a body of water including joining photovoltaic/solar cells to a float wrap material to form a joined assembly, placing the joined assembly over pre-positioned foam, and creating a covering assembly for a body of water by joining the float wrap material to a cover material at one or more seams.

### FIELD OF THE INVENTION

The present invention relates generally to improved processes and methods for implementing and installing coverings for bodies of water, such as reservoirs.

### BACKGROUND OF THE INVENTION

The methods of creating a reservoir cover are well known and usually, depending on the specific site and application, involve both field and shop seaming processes.

Usually field seaming is done using a hand operated heat gun, such as manufactured by LEISTER, Switzerland. Geomembrane cover materials include HYPALON, polypropylene, TPO (thermoplastic polyolefin), HDPE (high density polyethylene), LDPE (low density polyethylene), PVC (polyvinyl chloride), etc. These materials are manufactured as roll stock, and dimensions are limited to machine width and weight of the roll, due to handling difficulties. Field seaming is mostly done by hand and under difficult conditions, e.g., weather, night, human and environmental conditions, etc.

In order to allow covering large water surfaces at the shortest possible time, roll stock material is sometimes shop seamed in advance at the width in order to create a large and continuous portion of the cover, thereby severely limiting field seaming.

Reference is made to FIG. 1. Two known methods for creating foam floats are: 1) Prefabricating an open-end pouch (float wrap 1) that is shop-seamed to a cover material 2; then inserting foam 3 into the pouch; and then seaming the pouch end to close it in the field.

2) Prefabricating the entire foam float wrap 1; placing the float wrap 1 upon the foam 3; and afterwards seaming the wrap 1 to the cover material 2 using the above mentioned hand operated heat gun. (See FIG. 1.)

The difficulties associated with these operations are:

a. Operator's inability to continuously and repetitively maneuver the heat gun.

b. When moving too fast relative to the heat gun, a “cold seam” will occur.

c. When moving too slowly relative to the heat gun, the material may burn.

The heat gun itself needs to be checked and calibrated periodically in order to ensure proper working conditions, e.g., temperature, pressure and speed (for motor driven systems). The entire process is recorded, e.g., time, operator, temperature, heat gun, etc., and periodically destructive samples are obtained.

After the cover is finalized and in place, repairing a tear or puncture in the cover is done using a float positioned under the cover material that allows elevating that specific portion above the water level to be dry. The float also serves as a counter surface for pressing against while doing the seaming. Upon drying, seaming is then carried out with above mentioned techniques.

### SUMMARY OF THE INVENTION

The present invention seeks to provide improved processes and methods for implementing and installing coverings for bodies of water, such as reservoirs, as is described more in detail hereinbelow.

The invention is not limited to reservoirs and may be adapted to many different types of water bodies such as but not limited to, rivers, lakes, canals, open sea, etc., as well as to other liquids and semi-liquids (the term “water” encompassing liquids and semi-liquids).

While the use of the word “cover” generally relates to a membrane material capable of preventing or reducing evaporation of the water body, it is not limited or restricted to such a material and may include floating covers, buoys, panels, platforms and the like, also capable of preventing or reducing evaporation of the water body.

The cover may be part of a system for renewable energy (e.g., electricity), including, but not limited to, photovoltaic cells, solar cells, gas collection and/or creation, wind and wave power generation, etc.

### BRIEF DESCRIPTION OF THE DRAWINGS

The present invention will be understood and appreciated more fully from the following detailed description taken in conjunction with the appended drawings in which:

FIG. 1 is a simplified illustration of implementing a reservoir cover in the prior art; and

FIG. 2 is a simplified illustration of implementing a reservoir cover, in accordance with an embodiment of the present invention.

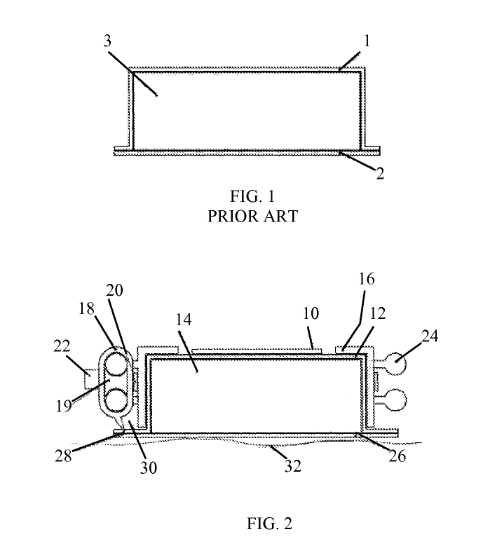

### DETAILED DESCRIPTION OF THE PRESENT INVENTION

The present invention seeks to provide improved methods of implementing a reservoir cover. The methods and systems of the present invention enhance, secure and assure reservoir performance, quality, output, maintainability and longevity.

The present invention different modular methods of implementation as follows:

Modular Method of Implementation Option 1:

1) Standard with roll stock material is supplied to fabrication facility.

2) Roll stock material is cut to desired lengths, and in accordance with design specifications, prefabrication stages are carried out.

3) Photovoltaic or solar cells are joined together with foam and geomembrane (solar/buoy assembly).

4) Solar/buoy assembly is seamed to cover material. (seaming process is automated as described below with reference to FIG. 2).

5) Entire assembly is transferred to site.

6) Entire assembly is seamed to each other to create a larger portion of the cover

Modular Method of Implementation Option 2:

First Three Steps—Same as Option 1

4) All subassemblies and prefabrications are transferred to site.

5) Solar/buoy assembly is seamed to cover material. (seaming process is automated as described below with reference to FIG. 2).

Step 6) Same as Option 1

Modular Method of Implementation Option 3:

Step 1—Same as Option 1 or 2

2) Roll stock material is cut to desired lengths and seamed at the width, and in accordance with design specifications, prefabrication stages are carried out (limiting factors being transportation and handling).

Steps 3-5 Same as Option 2

Modular Method of Implementation Option 4:

1) Standard with roll stock material is supplied to field site.

2) Roll stock material is seamed at the width using automated process and, if needed, cut to desired lengths in accordance with design specifications; prefabrication and pre-installation stages are executed.

3) Photovoltaic or solar cells are joined together with foam and geomembrane creating a solar/buoy assembly. This stage may also be shop-fabricated and supplied to the field site.

4) Solar/buoy assembly is seamed to cover material (seaming process is automated as described below with reference to FIG. 2).

Modular method of implementation option 5 (particularly applicable to an existing reservoir cover):

1) Photovoltaic or solar cells are joined together with foam and geomembrane creating a solar/buoy assembly either shop fabricated and supplied to the field site or created on site.

2) Solar/buoy assembly is seamed and or mechanically fastened to existing cover material.

The ability to efficiently, reliably and cost effectively create a reservoir cover is now described with reference to FIG. 2.

Photovoltaic/solar cells 10 are joined to float wrap material 12 (e.g., geomembrane material 12) using an automated or semi automated process (geomembrane material may be pre-cut or prefabricated).

The joined assembly is then placed over pre-positioned foam 14 and with the aid of a positioning and seaming frame 16 (or simply positioning frame 16), a solar/buoy assembly is created. The positioning and seaming frame 16 is constructed of light weight material and can be mass-produced cost-effectively.

A heat gun assembly 18 may be mounted with bearings 19 on a portion of positioning frame 16. A drive mechanism 20 having a motor 22 may be used to move the heat gun assembly 18, such as along one or more rails 24, to different positions along the float wrap material 12 so that the heat gun assembly 18 can join the float wrap material 12 to a cover material 26 at one or more seams 28 located along the boundaries of the assembly.

The positioning frame 16 can also operate with a vacuum system 30, either stationary or via the seaming assembly, or in motion, using a rotary vacuum system. The vacuum system 30 creates a vacuum between the float wrap material 12 and cover material 26 to ensure good bonding between the two. The vacuum is particular advantageous when it is required to install the cover material while floating on a water surface 32. Additionally, the vacuum technique, together with a prefabricated fastening system, simplifies seaming and deployment operations and shortens installation time.

The present invention includes both combinations and subcombinations of the features described hereinabove as well as modifications and variations thereof which would occur to a person of skill in the art upon reading the foregoing description and which are not in the prior art.

What is claimed is:

1. A method for creating a covering for a body of water comprising:
joining photovoltaic/solar cells to a float wrap material to form a joined assembly;
placing said joined assembly over pre-positioned foam; and
creating a covering assembly for a body of water by joining said float wrap material to a cover material at one or more seams.

2. The method according to claim 1, wherein said covering assembly is transported to a site of said body of water, and a plurality of said covering assemblies are seamed to each other to create a larger covering assembly.

3. The method according to claim 1, wherein the step of creating the covering assembly is done with a positioning and seaming frame arranged to move to different positions along said float wrap material and create the seams at the different positions.

4. A positioning and seaming frame comprising:
a positioning frame;
a heat gun assembly mounted on a portion of said positioning frame;
a drive mechanism operative to move said heat gun assembly to different positions along a float wrap material so that said heat gun assembly is arranged to join the float wrap material to a cover material at one or more seams.

5. The positioning and seaming frame according to claim 4, further comprising a vacuum system that creates a vacuum between the float wrap material and the cover material.
